(19) United States
(12) Patent Application Publication
(10) Pub. No.: US 2024/0231926 A9
(43) Pub. Date: Jul. 11, 2024

(54) NONINTELLIGENT ITEM CONVERSION TO INTELLIGENT ITEMS

(71) Applicant: International Business Machines Corporation, Armonk, NY (US)

(72) Inventors: Shailendra Moyal, PUNE (IN); Sarbajit K. Rakshit, KOLKATA (IN); Akash U. Dhoot, PUNE (IN); Shilpa Bhagwatprasad Mittal, PUNE (IN)

(21) Appl. No.: 18/048,294

(22) Filed: Oct. 20, 2022

(51) Int. Cl. G06F 9/50

(52) U.S. Cl. CPC G06F 9/5038

(57) ABSTRACT

A computer implemented method manages nonintelligent items. A computer system identifies a workflow to be performed. The computer system identifies a group of the nonintelligent items involved in actions for the workflow. The computer system attaches a set of computing devices to the group of the nonintelligent items to convert the group of the nonintelligent items into a group of converted nonintelligent items. The computer system performs the actions in the workflow using the group of converted nonintelligent items.

### BACKGROUND

### 1. Field

The disclosure relates generally to an improved computer system and more specifically to a computer implemented method, an apparatus, a system, and a computer program product for converting nonintelligent objects into intelligent objects.

### 2. Description of the Related Art

In many different environments, use cases are used at the beginning of projects and provide an understanding of interactions between components used in the projects. A workflow is an overall end to end process in which activities form the workflow. These activities can occur independently each other. Each activity can comprise a number of actions performed for the activity. A use case can have one more workflows that are performed for the use case.

Actions performed for a workflow can involve components in the form of intelligent items and nonintelligent items. For example, on a manufacturing floor, a robotic arm with an end effector is an intelligent item that can perform actions such as moving a part, installing a fastener, inspecting a part, and performing other actions to manufacture products. As another example, a workflow can be for the movement of cargo containers from a first location to a second location. Actions for this workflow can be performed using a robotic crane and a cargo container. The actions can include, for example, picking up a cargo container at the first location, moving the cargo container from the first location to the second location, and placing the cargo container at the second location. The robotic crane is an intelligent item, and the cargo container is a nonintelligent item.

### SUMMARY

According to one illustrative embodiment, a computer implemented method manages nonintelligent items. A computer system identifies a workflow to be performed. The computer system identifies a group of the nonintelligent items involved in actions for the workflow. The computer system attaches a set of computing devices to the group of the nonintelligent items to convert the group of the nonintelligent items into a group of converted nonintelligent items. The computer system performs the actions in the workflow using the group of converted nonintelligent items. According to other illustrative embodiments, a computer system, and a computer program product for managing nonintelligent items are provided.

### BRIEF DESCRIPTION OF THE DRAWINGS

FIG. 1 is a block diagram of a computing environment in which illustrative embodiments can be implemented;

FIG. 2 is a block diagram of a workflow environment in accordance with an illustrative embodiment;

FIG. 3 is a flowchart of a process for managing items to perform actions in a workflow in accordance with an illustrative embodiment;

FIG. 4 is a flowchart of a process of managing nonintelligent items during the performance of actions in a workflow in accordance with an illustrative embodiment;

FIG. 5 is a flowchart of a process for managing nonintelligent items in accordance with an illustrative embodiment;

FIG. 6 is a flowchart of a process for identifying a workflow in accordance with an illustrative embodiment;

FIG. 7 is a flowchart of a process for selecting computing devices for nonintelligent items in accordance with an illustrative embodiment;

FIG. 8 is a flowchart of a process for attaching computing devices to nonintelligent devices in accordance with an illustrative embodiment;

FIG. 9 is a flowchart of a process for transferring computing devices in accordance with an illustrative embodiment;

FIG. 10 is a flowchart of a process for transferring computing devices in accordance with an illustrative embodiment;

FIG. 11 is a flowchart of a process for performing actions in a workflow in accordance with an illustrative embodiment; and

FIG. 12 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

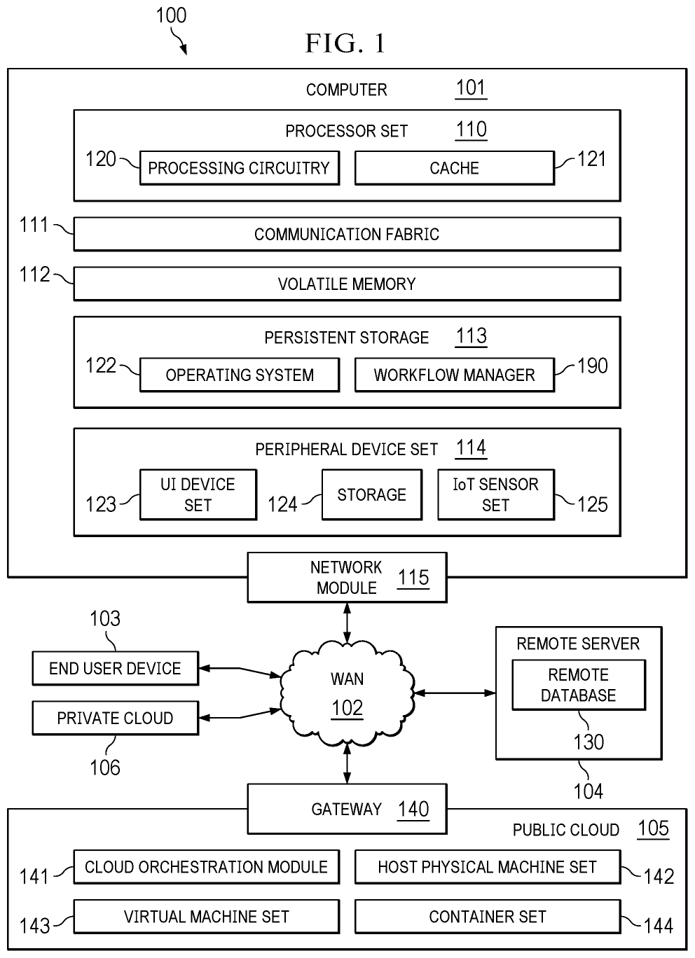

With reference now to the figures in particular with reference to FIG. 1, a block diagram of a computing environment is depicted in accordance with an illustrative embodiment. Computing environment 100 contains an example of an environment for the execution of at least some of the computer code involved in performing the inventive methods, such as workflow manager 190. Workflow manager 190 can manage intelligent items and nonintelligent items to perform actions in a workflow. The management of items can include converting nonintelligent items to have intelligence in performing actions in the workflow. In addition to workflow manager 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and workflow manager 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in workflow manager 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in workflow manager 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The illustrative embodiments recognize and take into account a number of different considerations as described herein. For example, the illustrative embodiments recognize and take into account that with intelligent devices and nonintelligent devices used to perform in a workflow, the intelligent devices can communicate with each other to perform actions in the workflow. For example, with an environment such as machine shop floor, various automated tools and machines can communicate with each other. Raw materials, parts, and other items are not intelligent items but are items used by the intelligent items to perform actions.

With nonintelligent items being unable to participate in communication with intelligent items, a gap in communication can occur. As a result, performance of the workflow can be less efficient than desired. One solution is to make nonintelligent items intelligent on a temporary basis based on the need of data for intelligent items in the workflow. The addition of intelligence to nonintelligent items can enable these items to communicate with other intelligent items in performing the workflow. This communication can increase the efficiency in perform actions in the workflow.

This increase in efficiency can be, for example, an improvement in accuracy in performing actions, reducing time to perform actions in the workflow, reducing damage to objects during manufacturing and other types of efficiencies. For example, adding intelligence to a cargo container can enable the cargo container to communicate with a robotic crane. The communications can include the cargo container sending position data to the robotic crane. This position data can increase the speed and accuracy in which robotic crane moves the cargo container from one location to another location while avoiding obstacles. Thus, this position data can also be used reduced the potential for damage to the cargo container and to cargo within the cargo container.

The illustrative embodiments provide a computer implemented method, computer system, and computer program product for managing nonintelligent items. A computer system identifies a workflow to be performed. The computer system identifies a group of the nonintelligent items involved in actions for the workflow. The computer system attaches a set of computing devices to the group of the nonintelligent items to convert the group of the nonintelligent items into a group of converted nonintelligent items. The computer system performs the actions in the workflow using the group of converted nonintelligent items.

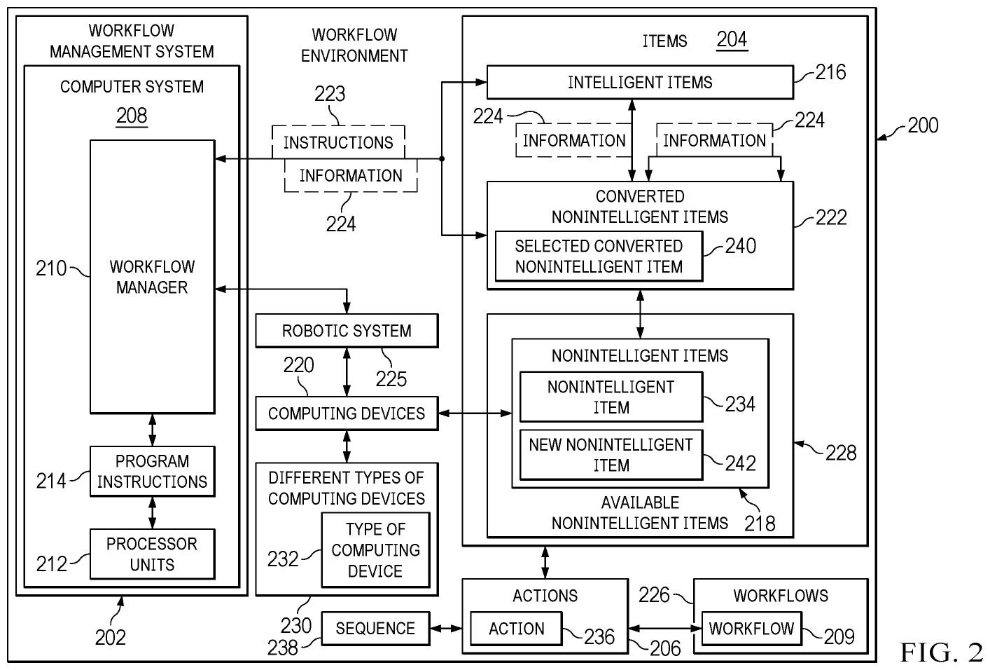

With reference now to FIG. 2, a block diagram of a workflow environment is depicted in accordance with an illustrative embodiment. In this illustrative example, workflow environment 200 includes components that can be implemented in hardware such as the hardware shown computing environment 100 in FIG. 1.

In this illustrative example, workflow environment 200 includes components that can be implemented in hardware such as the hardware shown in computing environment 100 in FIG. 1. As depicted, workflow management system 202 in workflow environment 200 can manage items 204 used to perform actions 206 for workflow 209. In this example, workflow management system 202 comprises computer system 208 and workflow manager 210.

Workflow manager 210 is an example of workflow manager 190 in FIG. 1. Workflow manager 210 can be implemented in software, hardware, firmware, or a combination thereof. When software is used, the operations performed by workflow manager 210 can be implemented in program instructions configured to run on hardware, such as a processor unit. When firmware is used, the operations performed by workflow manager 210 can be implemented in program instructions and data and stored in persistent memory to run on a processor unit. When hardware is employed, the hardware can include circuits that operate to perform the operations in workflow manager 210.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

Computer system 208 is a physical hardware system and includes one or more data processing systems. When more than one data processing system is present in computer system 208, those data processing systems are in communication with each other using a communications medium. The communications medium can be a network. The data processing systems can be selected from at least one of a computer, a server computer, a tablet computer, or some other suitable data processing system.

As depicted, computer system 208 includes a number of processor units 212 that are capable of executing program instructions 214 implementing processes in the illustrative examples. As used herein, a processor unit in the number of processor units 212 is a hardware device and is comprised of hardware circuits such as those on an integrated circuit that respond and process instructions and program instructions that operate a computer. A processor unit can be implemented using processor set 110 in FIG. 1.

When the number of processor units 212 execute program instructions 214 for a process, the number of processor units 212 is one or more processor units that can be on the same computer or on different computers. In other words, the process can be distributed between processor units on the same or different computers in computer system 208.

Further, the number of processor units 212 can be of the same type or different type of processor units. For example, the number of processor units 212 can be selected from at least one of a single core processor, a dual-core processor, a multi-processor core, a general-purpose central processing unit (CPU), a graphics processing unit (GPU), a digital signal processor (DSP), or some other type of processor unit.

In this illustrative example, items 204 are managed by workflow manager 210 to perform actions 206 for workflow 209. In this example, items 204 comprise intelligent items 216 and nonintelligent items 218. Workflow manager 210 can increase the efficiency of workflow 209. For example, workflow manager 210 can manage nonintelligent items 218. In this example, workflow manager 210 can add intelligence to a group of nonintelligent items 218.

As depicted in this illustrative example, workflow manager 210 identifies workflow 209 to be performed. Workflow manager 210 identifies a group of nonintelligent items involved in actions 206 for workflow 209. The group of nonintelligent items 218 can be some or all of nonintelligent items 218 used in workflow 209. In this example, a nonintelligent item being involved in an action means that the nonintelligent item can perform the action or can be used in the performance of the action.

Workflow manager 210 attaches a set of computing devices 220 to the group of the nonintelligent items 218 to convert the group of the nonintelligent items into a group of converted nonintelligent items 222. As used herein, a “set of” when used with reference items means one or more items. For example, a set of computing devices 220 is one or more computing devices 220. In this illustrative example, the set of computing devices 220 are removably attached to nonintelligent items 218. In other words, the attachment is temporary and the set of nonintelligent items are converted to a set of converted nonintelligent items having a temporary intelligence to involved in the performance of actions 206 for workflow 209.

In this illustrative example, a computing device in computing devices 220 is a physical device and includes hardware to process data. For example, the hardware can include a processor unit, memory, and other components used to at least one of generate data or process data. The hardware in a computing device can also include sensors. The computing device can have a housing or packaging that enables connecting the computing device to a nonintelligent item in nonintelligent items 218.

Computing devices 220 comprise different types of computing devices 230. In this illustrative example, workflow manager 210 can select type of computing device 232 for the set of computing devices 220 for nonintelligent item 234 in the group of the nonintelligent items 218 based on action 236 in actions 206 in workflow 209 in which the nonintelligent item 234 will be involved in performing. As a result, different nonintelligent items in the group of nonintelligent items 218 can have different types of computing devices 230 depending on the particular types of actions 206 that those nonintelligent items will be involved in for performance of actions 206.

A type of computing device for the set of computing devices 220 can be, for example, a sensor system, a single board computer such as a Raspberry Pi, a drone, and unmanned aerial vehicle, an inertial measurement unit (IMU) positioning system, a global positioning system device, a camera system, or some other suitable type of device. The computing device can be attached using a number of different mechanisms such as a mechanical fastener system, a magnetic lock system, or some other suitable attachment mechanism.

In this illustrative example, the hardware in the computing device has a wireless communication component that enables exchanging information 224. In some illustrative examples, the computing device can be a multifunction computing device that comprises combinations of these and other types of computing devices.

In one illustrative example, workflow manager 210 can control robotic system 225 to attach computing devices 220 to the group of nonintelligent items 218 selected for conversion. Robotic system 225 can be one or more robotic arms that can pick up and attach computing devices 220 to nonintelligent items 218.

In this example, workflow manager 210 performs actions 206 using the group of converted nonintelligent items 222. Workflow manager 210 can control at least one of a group of intelligent items 216 or a group of converted nonintelligent items 222 to perform actions 206 in workflow 209. For example, workflow manager 210 can send instructions 223 to at least one of the group of intelligent items 216 or the group of converted nonintelligent items 222 to perform actions 206. Instructions 223 are instructions received and processed by hardware in at least one of the group of intelligent items 216 or the group of converted nonintelligent items 222 to perform actions 206.

Instructions 223 can take a number of different forms. For example, instructions 223 can be selected from at least one of a command, data, program code, or other information that can be used by the group of intelligent items 216 for the group of nonintelligent items 218 to perform actions 206.

In this example, the group of intelligent items 216 and the group of converted nonintelligent items 222 communicate with each other in performing actions 206 in workflows 226. The communication of information can be sending information from converted nonintelligent items 222 to intelligent items 216, sending information 224 from intelligent items 216 to converted nonintelligent items 222, or both be sending information from converted nonintelligent items 222 to intelligent items 216 and sending information 224 from intelligent items 216 to converted nonintelligent items 222. Additionally, the group of intelligent items 216 and the group of converted nonintelligent items 222 can also communicate information 224 with workflow manager 210 during the performance of actions 206 for workflow 209.

As a result, the performance of actions 206 for workflow 209 can be performed using intelligent items 216 and a group of converted nonintelligent items 222. With these types of items, communication of information 224 can occur between intelligent items 216 and the group of converted nonintelligent items 222. This communication of information between these items can increase the efficiency in which actions 206 for workflow 209 are performed as compared to only using nonintelligent items 218. The performance of actions 206 can also be improved by the communication of information 224 between the group of converted nonintelligent items 222 and workflow manager 210.

With this additional communication that was previously unavailable, at least one of the group of intelligent items 216 or workflow manager 210 can be provided with additional information needed to perform actions 206 more efficiently. For example, the group of intelligent items 216 can include a robotic crane. This robotic crane can move nonintelligent items 218 in the form of cargo containers, which are nonintelligent items. By adding a computing device such as a positioning sensor system to a cargo container the cargo container can generate information about the location and orientation of the cargo container. This information can be used by the robotic crane to control movement of the cargo container. For example, the orientation of the cargo container may be used to determine when the cargo container is in a correct position to be placed in a storage location. As another example, this type of control can be performed by workflow manager 210 controlling the robotic crane.

As another example, the computing device can be a multifunction computing device that also includes vibration and accelerometer sensors. The sensors can be used to detect vibrations or accelerations indicating shifting of cargo within the cargo container. This information can be used to change the manner in which the cargo container is moved by the robotic crane to reduce shifting of the cargo within the cargo container. As are result, damage to cargo can be reduced or avoided.

In this illustrative example, the group of nonintelligent items 218 converted to a group of converted nonintelligent items 222 can be a subset of nonintelligent items 218. The group of nonintelligent items 218 selected for conversion can be based on the need for a communication of information 224. Additionally, the communication of information 224 can be within the group of converted nonintelligent items 222 between those items and intelligent items 216. In other words, converted nonintelligent items 222 can communicate with each other.

In identifying workflow 209 to be performed, workflow 209 can be selected from workflows 226. In this example, the selection of workflow 209 from workflows 226 can be made by analyzing actions 206 to be performed for workflow 209. This analysis can involve determining what nonintelligent items are needed to perform actions 206.

In this example, workflows 226 may be a list of workflows that are to be performed. In this example, workflow 209 can be selected based on the availability of nonintelligent items 218 needed to perform actions 206 for workflow 209.

Particular types of nonintelligent items 218 may be needed to perform actions 206 for workflow 209. For example, workflow 209 may be a cargo container movement workflow in which cargo containers are moved from a first location such as a ship to a second location such as a storage location. For example, available nonintelligent items 228 may be the presence of cargo containers that need to be moved from the ship to the storage location. Thus, the shipping container workflow can be selected for use when cargo containers are present for movement.

As another example, workflow 209 can be a workflow for loading objects into containers for shipping. In this example, the available nonintelligent items can be shipping boxes for receiving the objects for shipping. The availability of both of these nonintelligent items is needed for workflow 209 in this example.

In these illustrative examples, nonintelligent items 218 for workflow 209 can be involved in actions 206. A nonintelligent item can be involved in an action by being an object on which the action is performed for an actor performing the action.

Workflow manager 210 can select nonintelligent items 218 for use in workflow 209 based on which nonintelligent items 218 are available for use in workflow 209. In some illustrative examples, a nonintelligent item in nonintelligent items 218 may already be reserved or designated for use in another workflow.

Additionally, workflow manager 210 can select nonintelligent items 218 based on the availability of computing devices 220. For example, the number of computing devices 220 available for use with nonintelligent items 218 may be less than all of nonintelligent items 218 that is desired to be converted to converted nonintelligent items 222. If the number of computing devices 220 is limited, nonintelligent items 218 can be selected for attachment in which those nonintelligent items are needed sooner in sequence 238 of actions 206 as compared to other nonintelligent items 218. The computing devices can be moved at a later time when some of nonintelligent items 218 converted to converted nonintelligent items 222 are no longer involved or needed for actions 206.

In one illustrative example, workflow manager 210 selects the group of the nonintelligent items 218 for conversion to a group of converted nonintelligent items 222 based on sequence 238 of actions 206 in workflow 209. In other words, with a limited number of computing devices 220 suitable with use for nonintelligent items 218, nonintelligent items 218 can be selected for the limited number of computing devices 220 based on actions 206 that will be performed using those nonintelligent items sooner in sequence 238 of actions 206. Workflow manager 210 can attach the set of computing devices 220 to the group of the nonintelligent items 218 selected for the conversion.

In the illustrative example, workflow manager 210 can transfer a number of computing devices 220 in the set of computing devices 220 from a number of the converted nonintelligent items 222 in the group of converted nonintelligent items 222 to a number of nonintelligent items 218 without computing devices 220 based on sequence 238 of actions 206 to be performed in workflow 209. For example, computing devices 220 attached to a number of converted nonintelligent items 222 can be removed after those converted nonintelligent items have already been involved in actions 206 and the computing devices 220 are not needed for later actions in sequence 238 of actions 206. Those removed computing devices can then be attached to a number of nonintelligent items 218 that will be involved in later actions in sequence 238 of actions 206 that have not yet been formed in workflow 209.

In one example, workflow manager 210 can transfer a computing device in computing devices 220 by selecting selected converted nonintelligent item 240 and new nonintelligent item 242 for conversion based on actions 206 that have been performed and actions 206 that have not been performed in sequence 238 of actions 206 in workflow 209. Workflow manager 210 moves a computing device from selected converted nonintelligent item 240 to new nonintelligent item 242. In this example, selected converted nonintelligent item 240 no longer needs the computing device for upcoming actions in actions 206 that have not been performed in sequence 238 of actions 206 in workflows 226. New nonintelligent item 242 needs the computing device for an upcoming action in actions 206 that has not been performed in the sequence of actions in the workflow. As a result, the computing device can be moved from selected converted nonintelligent item 240 to new nonintelligent item 242.

For example, workflow manager 210 can move a computing device in the form of a positioning device from a first container to a second container after the first container has been moved to the desired location. In this example, the first container no longer needs the computing device, and the second container needs the computing device for use to provide positioning data during the movement of the second container.

In one illustrative example, one or more technical solutions are present that overcome a problem with performing workflows with a desired level of efficiency. As a result, one or more solutions may enable increasing the efficiency at which workflows are performed. This improvement in efficiency can be an improvement in accuracy, reduction in time, or other types of efficiencies.

Computer system 208 can be configured to perform at least one of the steps, operations, or actions described in the different illustrative examples using software, hardware, firmware or a combination thereof. As a result, computer system 208 operates as a special purpose computer system in which workflow manager 210 in computer system 208 enables promoting nonintelligent items into converted nonintelligent items that have an ability to process data and communicate with intelligent items in performing actions for a workflow. In particular, workflow manager 210 transforms computer system 208 into a special purpose computer system as compared to currently available general computer systems that do not have workflow manager 210. In the illustrative example, the use of workflow manager 210 in computer system 208 integrates processes into a practical application for managing nonintelligent items that increases the performance of computer system 208 performing a workflow.

The illustration of workflow environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, workflow manager 210 an manage the use of intelligent items 216 and nonintelligent items 218 for performing actions for one or more workflows in workflows 226 in addition or in place of workflow 209. As another example, additional; intelligent items and nonintelligent items can be present that are managed by workflow manager 210 to perform other workflows.

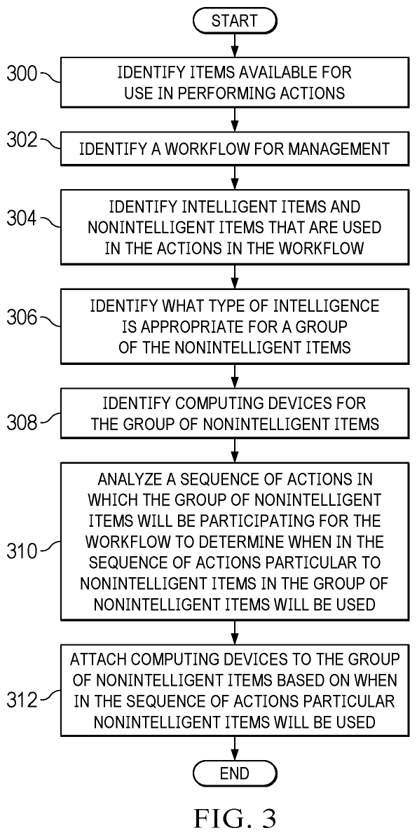

Turning next to FIG. 3, a flowchart of a process for managing items to perform actions in a workflow is depicted in accordance with an illustrative embodiment. The process in FIG. 3 can be implemented in hardware, software, or both. When implemented in software, the process can take the form of program instructions that is run by one of more processor units located in one or more hardware devices in one or more computer systems. For example, the process can be implemented in workflow manager 210 in computer system 208 in FIG. 2.

The process begins by identifying items available for use in performing actions (step 300). In step 300, an item repository can be maintained that identifies items that are registered for use in performing actions. This repository can categorize items as intelligent items and nonintelligent items.

In this example, intelligent items are physical items such as machines or equipment that can process data and perform actions. Further, these intelligent items can also communicate with other intelligent items in performing actions. The intelligent items in this example can be machine, equipment, materials, components, parts, objects, or other items that can process data.

The process identifies a workflow for management (step 302). In step 302, the workflow to be managed can be identified in a number of different ways. For example, the availability of intelligent items and nonintelligent items can be used to determine what workflows can be performed using these intelligent items and nonintelligent items. In another illustrative example, the workflow can be identified as a selection received from user. In another illustrative example, the workflow can be identified from analyzing actions performed in an environment such as a workshop, a workflow, assembly line, or other environment.

In this illustrative example, a workflow is an overall end to end process in which activities form the workflow and can be performed independently of each other. Each activity can comprise a number of actions performed for the activity.

The process identifies intelligent items and nonintelligent items that are used in the actions in the workflow (step 304). The process identifies what type of intelligence is appropriate for a group of the nonintelligent items (step 306). In step 306, the type of intelligence that is appropriate can be identified based on an analysis of previously actions performed for the workflow involving nonintelligent objects. For example, in determining the type of intelligence that is appropriate, the process can identify intelligent items and nonintelligent items involved in performing actions and can identify what communication using nonintelligent items can make the performance if the workflow more efficient.

In step 306, the process can identify what type of intelligence would be helpful in improving workflow performance. Improvement in workflow performance can include reducing time, reducing errors, increasing efficiency, reducing damage to items and products, and other desired goals for improving workflow performance. This identification can include determining what types of data generation processing and nonintelligent items would be helpful to increase the workflow performance.

The process identifies computing devices for the group of nonintelligent items (step 308). In this illustrative example, the capabilities for the group of nonintelligent items can be predesignated by a user designing the workflow. In other words, a user can assign types of computing devices to various nonintelligent items that will be involved in the workflow. This assignment can be stored and used for determining what capabilities will be needed by the different nonintelligent items.

In another example, the process can determine the types of data processing capabilities provided to the group of nonintelligent items would be helpful in performing the actions in the workflow. This determination can be performed through an analysis of actions using a machine learning model or other artificial intelligence system.

For example, with intelligent items in the form of a robotic crane and a nonintelligent item in the form of a cargo container, a robotic crane moves the cargo container to a storage location as part of a workflow. In this example, adding a sensor system to the cargo container that provides position data can increase performance in moving the cargo container. For example, the sensor system can provide a location of the cargo container in a three-dimensional space as well as an orientation of the cargo container. Location and orientation data can be used in determining how to place the cargo container in a particular location with other cargo containers at the storage location.

The process analyzes a sequence of actions in which the group of nonintelligent items will be participating for the workflow to determine when in the sequence of actions particular nonintelligent items in the group of nonintelligent items will be used (step 310).

The process attaches computing devices to the group of nonintelligent items based on when in the sequence of actions particular nonintelligent items will be used (step 312). In step 312, a robotic system attaches the computing devices to the group of nonintelligent items to convert the nonintelligent items into converted nonintelligent items having intelligence to participate in the actions. These converted nonintelligent items can at least one of generated data, process data, or perform actions.

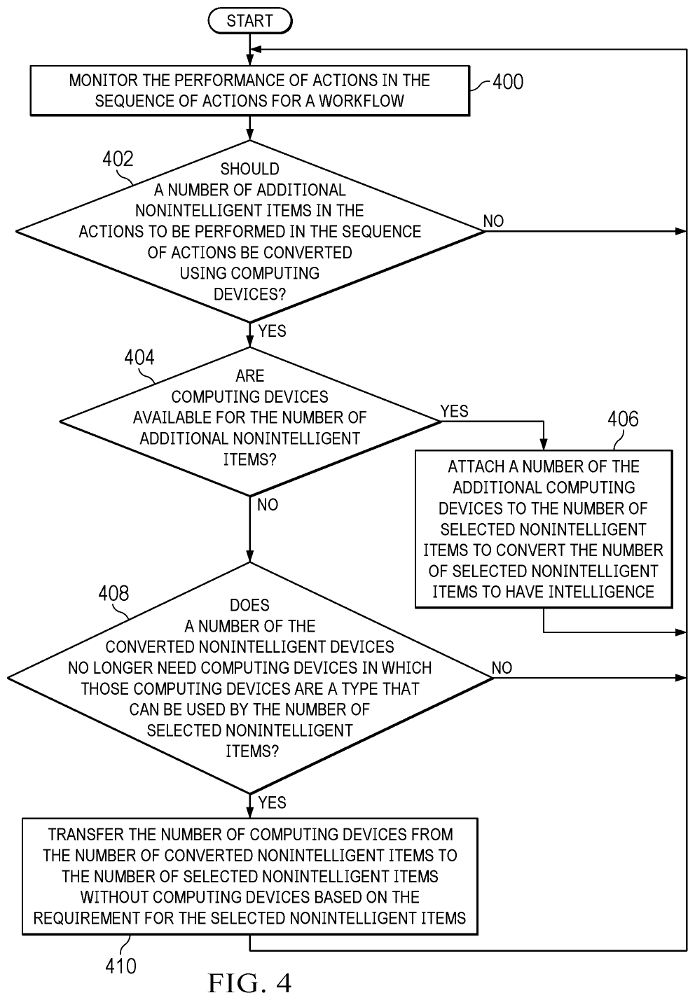

Turning to FIG. 4, a flowchart of a process of managing nonintelligent items during the performance of actions in a workflow is depicted in accordance with an illustrative embodiment. The process in FIG. 4 can be implemented in hardware, software, or both. When implemented in software, the process can take the form of program instructions that is run by one of more processor units located in one or more hardware devices in one or more computer systems. For example, the process can be implemented in workflow manager 210 in computer system 208 in FIG. 2.

The process begins by monitoring the performance of actions in the sequence of actions for a workflow (step 400). In step 400, monitoring can be performed from receiving data from the intelligent items and from converted nonintelligent items involved in actions for the workflow. Additionally, sensor systems separate from the items in the workflow can also be present that monitor the actions being performed.

The process determines whether a number of additional nonintelligent items in the actions to be performed in the sequence of actions should be converted using computing devices (step 402). In step 402, the process can take into account that a limited number of computing devices may be present. In other words, computing devices may not be available for all of the nonintelligent devices that need computing devices for use in performing the actions in the workflow.

Additionally, in step 402, the process can also analyze the context of actions being performed to determine whether nonintelligent items not previously identified as needing intelligence should have intelligence to increase the efficiency in performing the workflow. This type of analysis can be made using a machine learning model for other artificial intelligence systems. This type of analysis can be useful when selected actions in the workflow are repeated a number of times.

If a number of selected nonintelligent items should be converted, the process determines whether computing devices are available for the number of additional nonintelligent items (step 404). The determination in step 404 takes into account whether selected types of computing devices needed to convert the number of selected nonintelligent items are available.

If additional computing devices are available, the process attaches a number of the additional computing devices to the number of selected nonintelligent items to convert the number of selected nonintelligent items to have intelligence (step 406). In step 406, additional computing devices may be available for some but not all of the number of selected nonintelligent items. In this case, the conversion is performed for nonintelligent items for which computing devices are available. The process then returns to step 400.

In step 404, if additional computing devices are not available for the number of selected nonintelligent items, the process determines whether a number of the converted nonintelligent devices no longer need computing devices in which those computing devices are a type that can be used by the number of selected nonintelligent items (step 408). In step 408, one or more of the already converted nonintelligent devices may no longer need intelligence. A converted nonintelligent device may no longer be involved in actions requiring intelligence. For example, a cargo container with a positioning sensor system that has been moved to a storage location, no longer needs the positioning sensor system. This positioning sensor system can be transferred to another cargo container that will be moved to the storage location.

If a number of converted nonintelligent items no longer need the number of computing devices, the process transfers the number of computing devices from the number of converted nonintelligent items to the number of selected nonintelligent items without computing devices based on the requirement for the selected nonintelligent items (step 410). In step 410, the transfer of the number of computing devices can be performed in an appropriate sequence based on a sequence of actions and when particular selected nonintelligent items are involved in the sequence of actions.

The process then returns to step 400. The process also returns to step 400 if the number of converted intelligent devices no longer need computing devices. With reference again to step 402, if the number of additional nonintelligent items in the actions to be performed in the sequence of actions should not be converted using computing devices, then the process returns to step 400 for continued monitoring of the performance actions involving nonintelligent items.

Thus, the process in FIG. 4 can monitor the performance of actions and add intelligence to nonintelligent computing devices as needed. These additions can be made based on at least one of a presence of a limited number of computing devices, and identification of additional intelligence needed based on a context of actions being performed for the workflow, and other factors. In one example context, the process can determine whether the output of one nonintelligent object after making the nonintelligent item intelligent will be an input for another nonintelligent item. This determination can be used to determine additional nonintelligent items that may need conversion to become converted nonintelligent items to add intelligence to the workflow.

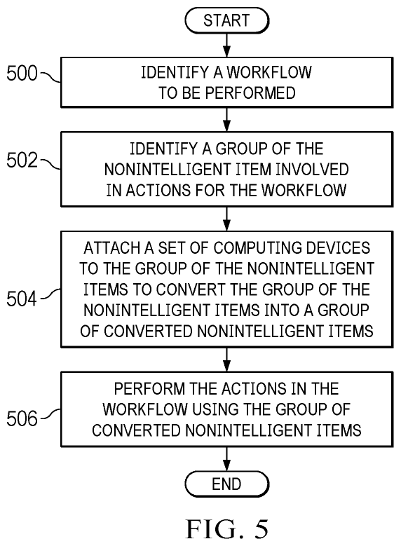

With reference to FIG. 5, a flowchart of a process for managing nonintelligent items is depicted in accordance with an illustrative embodiment. The process in FIG. 5 can be implemented in hardware, software, or both. When implemented in software, the process can take the form of program instructions that are run by one or more processor units located in one or more hardware devices in one or more computer systems. For example, the process can be implemented in workflow manager 210 in computer system 208 in FIG. 2.

The process begins by identifying a workflow to be performed (step 500). The process identifies a group of the nonintelligent items involved in actions for the workflow (step 502).

The process attaches a set of computing devices to the group of the nonintelligent items to convert the group of the nonintelligent items into a group of converted nonintelligent items (step 504). The process performs the actions in the workflow using the group of converted nonintelligent items (step 506). The process terminates thereafter.

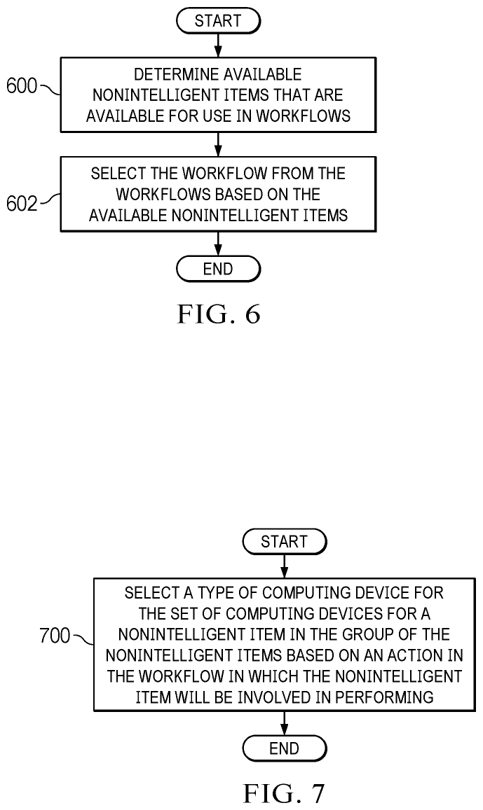

Turning now to FIG. 6, a flowchart of a process for identifying a workflow is depicted in accordance with an illustrative embodiment. The process in FIG. 6 is an example of an implementation for step 502 in FIG. 5.

The process begins by determining available nonintelligent items that are available for use in workflows (step 600). The process selects the workflow from the workflows based on the available nonintelligent items (step 602). The process terminates thereafter.

In FIG. 7, a flowchart of a process for selecting computing devices for nonintelligent items is depicted in accordance with an illustrative embodiment. The process in FIG. 7 is an example of an additional step that can be performed in the process in FIG. 5.

The process selects a type of computing device for the set of computing devices for a nonintelligent item in the group of the nonintelligent items based on an action in the workflow in which the nonintelligent item will be involved in performing (step 700). The process terminates thereafter.

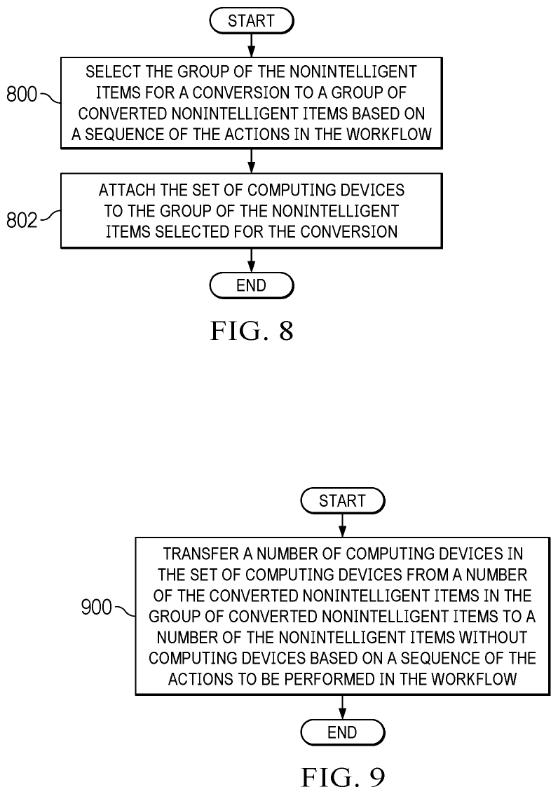

Turning next to FIG. 8, a flowchart of a process for attaching computing devices to nonintelligent devices is depicted in accordance with an illustrative embodiment. The process in FIG. 8 is an example of an implementation of step 504 in FIG. 5.

The process begins by selecting the group of the nonintelligent items for a conversion to a group of converted nonintelligent items based on a sequence of the actions in the workflow (step 800). The process attaches the set of computing devices to the group of the nonintelligent items selected for the conversion (step 802). The process terminates thereafter.

With reference now to FIG. 9, a flowchart of a process for transferring computing devices is depicted in accordance with an illustrative embodiment. The process in FIG. 9 is an example of an additional step that can be performed in the process in FIG. 5.

The process transfers a number of computing devices in the set of computing devices from a number of the converted nonintelligent items in the group of converted nonintelligent items to a number of the nonintelligent items without computing devices based on a sequence of the actions to be performed in the workflow (step 900). The process terminates thereafter.

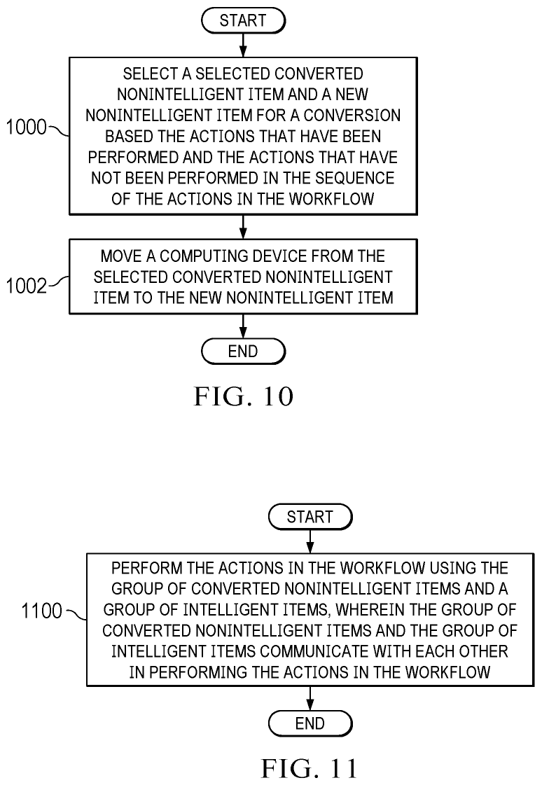

Next in FIG. 10, a flowchart of a process for transferring computing devices is depicted in accordance with an illustrative embodiment. The process in FIG. 10 is an example of an implementation for step 900 in FIG. 9. This process can be repeated any number of times for converted nonintelligent items during the performance of actions in the workflow. In other words, this process can continue to reallocate computing devices as needed based on the sequence of actions that are still to be performed.

The process begins by selecting a selected converted nonintelligent item and a new nonintelligent item for a conversion based the actions that have been performed and the actions that have not been performed in the sequence of the actions in the workflow (step 1000). The process moves a computing device from the selected converted nonintelligent item to the new nonintelligent item (step 1002). The process terminates thereafter.

Thus, in FIG. 10 the selected converted nonintelligent item no longer needs the computing device for an upcoming action in the actions that has not been performed in the sequence of the actions in the workflow. In this example, the new nonintelligent item needs the computing device for an upcoming action in the actions that have not been performed in the sequence of the actions in the workflow.

Turning to FIG. 11, a flowchart of a process for performing actions in a workflow is depicted in accordance with an illustrative embodiment. The process in FIG. 11 is an example of an implementation for step 506 in FIG. 5.

The process performs the actions in the workflow using the group of converted nonintelligent items and a group of intelligent items, wherein the group of converted nonintelligent items and the group of intelligent items communicate with each other in performing the actions in the workflow (step 1100). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

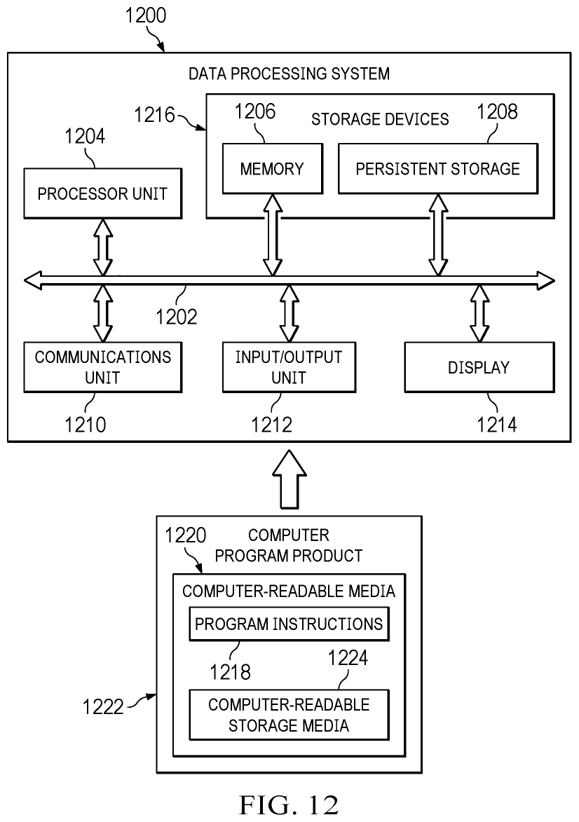

Turning now to FIG. 12, a block diagram of a data processing system is depicted in accordance with an illustrative embodiment. Data processing system 1200 can be used to implement computers and computing devices in computing environment 100 in FIG. 1. Data processing system 1200 can be used to implement computer system 208, computing devices 220, robotic system 225 or other data processing systems that can be used in FIG. 2. In this illustrative example, data processing system 1200 includes communications framework 1202, which provides communications between processor unit 1204, memory 1206, persistent storage 1208, communications unit 1210, input/output (I/O) unit 1212, and display 1214. In this example, communications framework 1202 takes the form of a bus system.

Processor unit 1204 serves to execute instructions for software that can be loaded into memory 1206. Processor unit 1204 includes one or more processors. For example, processor unit 1204 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1204 can may be implemented using one or more heterogeneous processor systems in which a main processor is present with secondary processors on a single chip. As another illustrative example, processor unit 1204 can be a symmetric multi-processor system containing multiple processors of the same type on a single chip.

Memory 1206 and persistent storage 1208 are examples of storage devices 1216. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1216 may also be referred to as computer readable storage devices in these illustrative examples. Memory 1206, in these examples, can be, for example, a random-access memory or any other suitable volatile or non-volatile storage device. Persistent storage 1208 may take various forms, depending on the particular implementation.

For example, persistent storage 1208 may contain one or more components or devices. For example, persistent storage 1208 can be a hard drive, a solid-state drive (SSD), a flash memory, a rewritable optical disk, a rewritable magnetic tape, or some combination of the above. The media used by persistent storage 1208 also can be removable. For example, a removable hard drive can be used for persistent storage 1208.

Communications unit 1210, in these illustrative examples, provides for communications with other data processing systems or devices. In these illustrative examples, communications unit 1210 is a network interface card.

Input/output unit 1212 allows for input and output of data with other devices that can be connected to data processing system 1200. For example, input/output unit 1212 may provide a connection for user input through at least one of a keyboard, a mouse, or some other suitable input device. Further, input/output unit 1212 may send output to a printer. Display 1214 provides a mechanism to display information to a user.

Instructions for at least one of the operating system, applications, or programs can be located in storage devices 1216, which are in communication with processor unit 1204 through communications framework 1202. The processes of the different embodiments can be performed by processor unit 1204 using computer-implemented instructions, which may be located in a memory, such as memory 1206.

These instructions are referred to as program instructions, computer usable program instructions, or computer readable program instructions that can be read and executed by a processor in processor unit 1204. The program instructions in the different embodiments can be embodied on different physical or computer readable storage media, such as memory 1206 or persistent storage 1208.

Program instructions 1218 is located in a functional form on computer readable media 1220 that is selectively removable and can be loaded onto or transferred to data processing system 1200 for execution by processor unit 1204. Program instructions 1218 and computer readable media 1220 form computer program product 1222 in these illustrative examples. In the illustrative example, computer readable media 1220 is computer readable storage media 1224.

Computer readable storage media 1224 is a physical or tangible storage device used to store program instructions 1218 rather than a medium that propagates or transmits program instructions 1218. Computer readable storage media 1224, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 1218 can be transferred to data processing system 1200 using a computer readable signal media. The computer readable signal media are signals and can be, for example, a propagated data signal containing program instructions 1218. For example, the computer readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer readable media 1220” can be singular or plural. For example, program instructions 1218 can be located in computer readable media 1220 in the form of a single storage device or system. In another example, program instructions 1218 can be located in computer readable media 1220 that is distributed in multiple data processing systems. In other words, some instructions in program instructions 1218 can be located in one data processing system while other instructions in program instructions 1218 can be located in one data processing system. For example, a portion of program instructions 1218 can be located in computer readable media 1220 in a server computer while another portion of program instructions 1218 can be located in computer readable media 1220 located in a set of client computers.

The different components illustrated for data processing system 1200 are not meant to provide architectural limitations to the manner in which different embodiments can be implemented. In some illustrative examples, one or more of the components may be incorporated in or otherwise form a portion of, another component. For example, memory 1206, or portions thereof, may be incorporated in processor unit 1204 in some illustrative examples. The different illustrative embodiments can be implemented in a data processing system including components in addition to or in place of those illustrated for data processing system 1200. Other components shown in FIG. 12 can be varied from the illustrative examples shown. The different embodiments can be implemented using any hardware device or system capable of running program instructions 1218.

Thus, illustrative embodiments provide a computer implemented method, computer system, and computer program product for managing nonintelligent items. A computer system identifies a workflow to be performed. The computer system identifies a group of the nonintelligent items involved in actions for the workflow. The computer system attaches a set of computing devices to the group of the nonintelligent items to convert the group of the nonintelligent items into a group of converted nonintelligent items. The computer system performs the actions in the workflow using the group of converted nonintelligent items.

With the ability to make nonintelligent items intelligent, the converted nonintelligent items can participate in communications with other intelligent items and other converted nonintelligent items. These communications can provide increased information two reduce issues in the performance of actions in the workflow. The communications can increase the efficiency in performing actions for the workflow.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method for managing nonintelligent items, the computer implemented method comprising:
identifying, by a computer system, a workflow to be performed;
identifying, by the computer system, a group of the nonintelligent items involved in actions for the workflow;
attaching, by the computer system, a set of computing devices to the group of the nonintelligent items to convert the group of the nonintelligent items into a group of converted nonintelligent items; and
performing, by the computer system, the actions in the workflow using the group of converted nonintelligent items.

2. The computer implemented method of claim 1, wherein identifying, by the computer system, the workflow to be performed comprises:
determining, by the computer system, available nonintelligent items that are available for use in workflows; and
selecting, by the computer system, the workflow from the workflows based on the available nonintelligent items.

3. The computer implemented method of claim 1 further comprising:
selecting, by the computer system, a type of computing device for the set of computing devices for a nonintelligent item in the group of the nonintelligent items based on an action in the workflow in which the nonintelligent item will be involved in performing.

4. The computer implemented method of claim 1, wherein attaching, by the computer system, the set of computing devices to the group of the nonintelligent items to convert the group of the nonintelligent items into the group of converted nonintelligent items comprises:
selecting, by the computer system, the group of the nonintelligent items for a conversion to a group of converted nonintelligent items based on a sequence of the actions in the workflow; and
attaching, by the computer system, the set of computing devices to the group of the nonintelligent items selected for the conversion.

5. The computer implemented method of claim 1 further comprising:
transferring, by the computer system, a number of computing devices in the set of computing devices from a number of the converted nonintelligent items in the group of converted nonintelligent items to a number of the nonintelligent items without computing devices based on a sequence of the actions to be performed in the workflow.

6. The computer implemented method of claim 5, wherein transferring, by the computer system, the number of computing devices in the set of computing devices from the number of the converted nonintelligent items in the group of converted nonintelligent items to the number of the nonintelligent items without computing devices based on the sequence of the actions to be performed in the workflow comprises:
selecting, by the computer system, a selected converted nonintelligent item and a new nonintelligent item for a conversion based the actions that have been performed and the actions that have not been performed in the sequence of the actions in the workflow; and
moving, by the computer system, a computing device from the selected converted nonintelligent item to the new nonintelligent item.

7. The computer implemented method of claim 6, wherein the selected converted nonintelligent item no longer needs the computing device for an upcoming action in the actions that has not been performed in the sequence of the actions in the workflow and the new nonintelligent item needs the computing device for an upcoming action in the actions that have not been performed in the sequence of the actions in the workflow.

8. The computer implemented method of claim 1, wherein attaching, by the computer system, the set of computing devices to the set of the nonintelligent items comprises:
attaching, by the computer system, a set of computing devices to the group of the nonintelligent items using a robotic system.

9. The computer implemented method of claim 1, wherein performing, by the computer system, the actions in the workflow using the group of converted nonintelligent items comprises:
performing, by the computer system, the actions in the workflow using the group of converted nonintelligent items and a group of intelligent items, wherein the group of converted nonintelligent items and the group of intelligent items communicate with each other in performing the actions in the workflow.

10. A computer system comprising:
a number of processor units, wherein the number of processor units executes program instructions to:
identify a workflow to be performed;
identify a group of nonintelligent items involved in actions for the workflow;
attach a set of computing devices to the group of the nonintelligent items to convert the group of the nonintelligent items into a group of converted nonintelligent items; and
perform the actions in the workflow using the group of converted nonintelligent items.

11. The computer system of claim 10, wherein in identifying the workflow to be performed, the number of processor units executes the program instructions to:
determine available nonintelligent items that are available for use in workflows; and
select the workflow from the workflows based on the available nonintelligent items.

12. The computer system of claim 10, wherein the number of processor units executes the program instructions to:
select a type of computing device for the set of computing devices for a nonintelligent item in the group of the nonintelligent items based on an action in the workflow in which the nonintelligent item will be involved in performing.

13. The computer system of claim 10, wherein in attaching the set of computing devices to the group of the nonintelligent items to convert the group of the nonintelligent items into a group of converted nonintelligent items, the number of processor units executes the program instructions to:
select the group of the nonintelligent items for a conversion to a group of converted nonintelligent items based on a sequence of the actions in the workflow; and
attach the set of computing devices to the group of the nonintelligent items selected for the conversion.

14. The computer system of claim 10, wherein the number of processor units executes the program instructions to:
transfer a number of computing devices in the set of computing devices from a number of the converted nonintelligent items in the group of converted nonintelligent items to a number of the nonintelligent items without computing devices based on a sequence of the actions to be performed in the workflow.

15. The computer system of claim 14, wherein in transferring the number of computing devices in the set of computing devices from the number of the converted nonintelligent items in the group of converted nonintelligent items to the number of the nonintelligent items without computing devices based on the sequence of the actions to be performed in the workflow, the number of processor units executes the program instructions to:
select a selected converted nonintelligent item and a new nonintelligent item for a conversion based the actions that have been performed and the actions that have not been performed in the sequence of the actions in the workflow; and
move a computing device from the selected converted nonintelligent item to the new nonintelligent item.

16. The computer system of claim 15, wherein the selected converted nonintelligent item no longer needs the computing device for an upcoming action in the actions that has not been performed in the sequence of the actions in the workflow and the new nonintelligent item needs the computing device for an upcoming action in the actions that have not been performed in the sequence of the actions in the workflow.

17. The computer system of claim 10, wherein in attaching the set of computing devices to the set of the nonintelligent items, the number of processor units executes the program instructions to:
attach a set of computing devices to the group of the nonintelligent items using a robotic system.

18. The computer system of claim 10, wherein in performing the actions in the workflow using the group of converted nonintelligent items, the number of processor units executes the program instructions to:
perform the actions in the workflow using the group of converted nonintelligent items and a group of intelligent items, wherein the group of converted nonintelligent items and the group of intelligent items communicate with each other in performing the actions in the workflow.

19. A computer program product for managing nonintelligent items, the computer program product comprising a computer readable storage medium having program instructions embodied therewith, the program instructions executable by a computer system to cause the computer system to perform a method of:
identifying, by the computer system, a workflow to be performed;
identifying, by the computer system, a group of the nonintelligent items involved in actions for the workflow;
attaching, by the computer system, a set of computing devices to the group of the nonintelligent items to convert the group of the nonintelligent items into a group of converted nonintelligent items; and
performing, by the computer system, the actions in the workflow using the group of converted nonintelligent items.

20. The computer program product of claim 19, wherein identifying, by the computer system, the workflow to be performed comprises:
determining, by the computer system, available nonintelligent items that are available for use in workflows; and
selecting the workflow from the workflows based on the available nonintelligent items.
